(19) United States
(12) Patent Application Publication
(10) Pub. No.: US 2013/0021618 A1
(43) Pub. Date: Jan. 24, 2013

(54) APPARATUS AND METHOD TO INDICATE A SPECIFIED POSITION USING TWO OR MORE INTERSECTING LASERS LINES

(71) Applicants: Kenneth Trent, Saint George, UT (US); Brock Taylor Belliston, Washington, UT (US)

(72) Inventors: Kenneth Trent, Saint George, UT (US); Brock Taylor Belliston, Washington, UT (US)

(21) Appl. No.: 13/184,875

(22) Filed: Jul. 18, 2011

(51) Int. Cl. G01B 11/14; G03B 21/14; G06F 15/00

(52) U.S. Cl. 356/614; 702/150; 353/85

(57) ABSTRACT

A laser projection apparatus and method for identifying specified coordinates on varied surfaces. A controller directs two or more laser projectors to intersect laser lines at a specified location. The locations of the modules are identified by calculating a rotational angle and two or more known coordinates. Once the location of the modules is calculated, angle to angle intersection is used to identify additional locations. The user indicates with the controller which location is to be identified. The controller processes the calculations and commands the laser projectors to draw the intersecting laser lines at the specified location. The intersecting laser lines are actuated in a strobe effect to attract the user's attention to the position. This apparatus and method allows users to quickly and easily locate specified locations without needing to take individual measurements for the purposes of alignment, construction, verification and the like.

### BACKGROUND OF INVENTION

1. Field of Invention

The present invention generally relates to a method and device for identifying specified coordinates using two or more visible lasers. In more detail, the present invention relates to using two or more visible lasers lines and a method for calculating an angle to angle intersection to obtain the coordinates of predetermined locations.

The art of large scale measurement and surveying involves the determination of unknown positions, or setting out of known coordinates using angle and distance measurements taken from one or more positions. In order to make these measurements, a surveying device or instrument frequently used is the type which is often called a total station. A total station is an electronic theodolite integrated with an electronic distance meter to read slope distances from the instrument to a particular point. The total station distance measuring instrument is capable of processing integrated distance and angular measurement calculations. A total station is furthermore provided with a computer control unit that records measurements and stores data obtained during the measurement process. This computer control unit is often referred to as a data collector. Preferably, the total station calculates the position of a target in a fixed ground-based coordinate system. Although total stations are well known, they have various disadvantages when used in small scale engineering surveys. The survey information although high quality in terms of accuracy, is time consuming and expensive to conduct, and normally requires at least two people.

Additional inexpensive and well known manual methods of measurement are often used to identify locations used in construction. These methods generally involve identifying a starting point or location and measuring the distance to additional points. Further measurements must be taken to ensure that the lines are perpendicular and that corners are thus 90 degree angles. A tape measure or appropriate device is used to measure the hypotenuse of a right triangle defined by the previously identified points. If a 90 degree angle is not achieved, then the previously identified points must be moved and the distance measured again. The workers move the points and measure the distance again and again until the right distance and angles are found and result in defining the correct layout. This process often takes a considerable amount of time and requires two or more workers to perform the process. Further, because the workers' best guess or estimation is utilized in positioning the points, the possibility for error is greatly increased.

2. Prior Art

The following is a tabulation of some prior art that presently appears relevant:

### U.S. Patents

| Pat. No. | Kind Code | Issue Date | Patentee |
|---|---|---|---|
| 3,865,491 | C1 | Feb. 11^{th}, 1975 | William M. Hogan |
| 3,471,234 | C1 | Oct. 7^{th}, 1969 | Robert H. Studebaker |
| 4,820,041 | C1 | Apr. 11^{th}, 1989 | Richard W. Davidson |
| 4,912,643 | C1 | Mar. 27, 1990 | Terence P. Beirxe |
| 4,688,933 | C1 | Aug. 25^{th}, 1987 | James M. Lapeyre |
| 7,181,853 | C1 | Feb. 27, 2007 | Charles E. Heger |
| 7,287,336 | C1 | Oct. 30, 2007 | Gary Goodrich |

For large scale measurement and surveying it is often necessary to accurately position an optical instrument such as a telescope, a camera, a range finder, a laser or the like. Generally, human intervention is required to align such optical instruments with a desired target. Human operation of optical instruments is not only expensive, but is sometimes subject to inaccuracies and errors, especially in cases where humans are required to estimate the location over and over until the desired target is identified.

Specifically in surveying operations it is often required to direct a laser beam upon a surveying stadia rod, prism or similar target. In some systems an operator is required at the laser support to continuously position the laser beam so as to impinge upon the stadia rod or prism. In other systems, the laser beam is continuously rotated about a horizontal plane in order to periodically impinge upon a stadia rod, prism or another measuring target. Current Surveying systems often have complicated operating procedures and require expensive equipment Examples of such laser surveying systems are found in U.S. Pat. No. 3,865,491 issued Feb. 11, 1975, and U.S. Pat. No. 3,471,234 issued Oct. 7, 1969.

Surveying and measuring systems that utilize the observation of angles for identifying an unknown position or target are used with both large scale and small scale measurement and position identification. These position identification systems will often utilize 2 or more base stations to project a visible or non-visible light source, and take measurements based on the location of said base stations. These positions identification systems often require a stadia rod, prism or other measuring target in order to detect and calculate the desired coordinates and locations. Systems of this nature are not as widely utilized in land surveying and construction and often require expensive equipment and additional training. Examples of such laser position detection systems are found in U.S. Pat. No. 4,820,041 issued on Apr. 11, 1989, U.S. Pat. No. 4,912,643 issued on Mar. 27, 1990, and U.S. Pat. No. 4,688,933 issued on Aug. 25, 1987.

Laser dot and laser line projection systems are often used in construction to generate parallel planes, identify straight lines or point to specified locations. When utilizing visible laser projection systems, it is often necessary to manually measure the position of the lasers in order to identify the desired location. Measurement errors may be produced in the event the user did not calculate the position of the laser correctly. Examples of such laser projection systems are found in U.S. Pat. No. 7,181,853 issued on Feb. 27, 2007, and U.S. Pat. No. 7,287,336 issued on Oct. 30, 2007.

### SUMMARY OF INVENTION

One or more implementations of the invention is to provide a laser projection system and method that allows users to quickly and easily locate specified locations without needing to take individual measurements for the purposes of alignment, construction layout, location verification and the like.

The advantages and novel features of the invention will become more apparent from the following detailed description when taken in conjunction with the accompanying drawings.

Accordingly, one or more embodiments provide a method and apparatus for calculating and identifying specified locations that does not require a stadia rod or prism, that requires only one person to operate, that utilize visible lasers that are actuated to draw a line for better visibility, that utilizes two or more laser lines that intersect at specified locations for simplified position identification, that can accurately locate or measure X and Y distance even when there is a difference in elevation, that reduces measurement error, that requires minimal training, and that is relatively inexpensive. Other advantages of one or more aspects will be apparent from consideration of the drawings and ensuing description.

### BRIEF DESCRIPTION OF THE DRAWINGS

FIG. 1 shows an embodiment of the laser projection apparatus according to the present invention.

FIG. 2 is a simplified perspective view of the laser projector

FIG. 3 is an exploded view of the laser projector

FIG. 4 shows a flowchart of the operation of the system according to the invention

FIG. 5 illustrates the measuring method used

### LIST OF DRAWINGS REFERENCE NUMBERS

110 First Laser Projector
120 Second Laser Projector
130 First Tripod
140 Second Tripod
150 First Laser Beam
160 Second Laser Beam
170 first Laser Line
180 Second Laser Line
190 Specified Location
195 Data Collector
210 Laser Window
220 Top Cover
230 Rotation Assembly
240 Base Housing
250 On/Off Switch
310 Single Board Computer
320 Motor
330 Galvanometer
340 Laser
350 Laser Mount
360 Light Detector
370 Encoder
381 First Pulley
382 Second Pulley
390 Drive Belt
410 Power On
420 Connect Confirmation
430 Receive Command
440 Process Command
445 Control Program
450 Update Galvo
460 Update Motor
470 Read Encoder
480 Read Light Detector
490 Transmit Status

### DETAILED DESCRIPTION OF THE INVENTION

One embodiment of the present invention will now be explained in detail with reference to the drawings. It should be understood, however, that this embodiment is an example. The range of technical applications of the present invention should not be limited to the preferred embodiment.

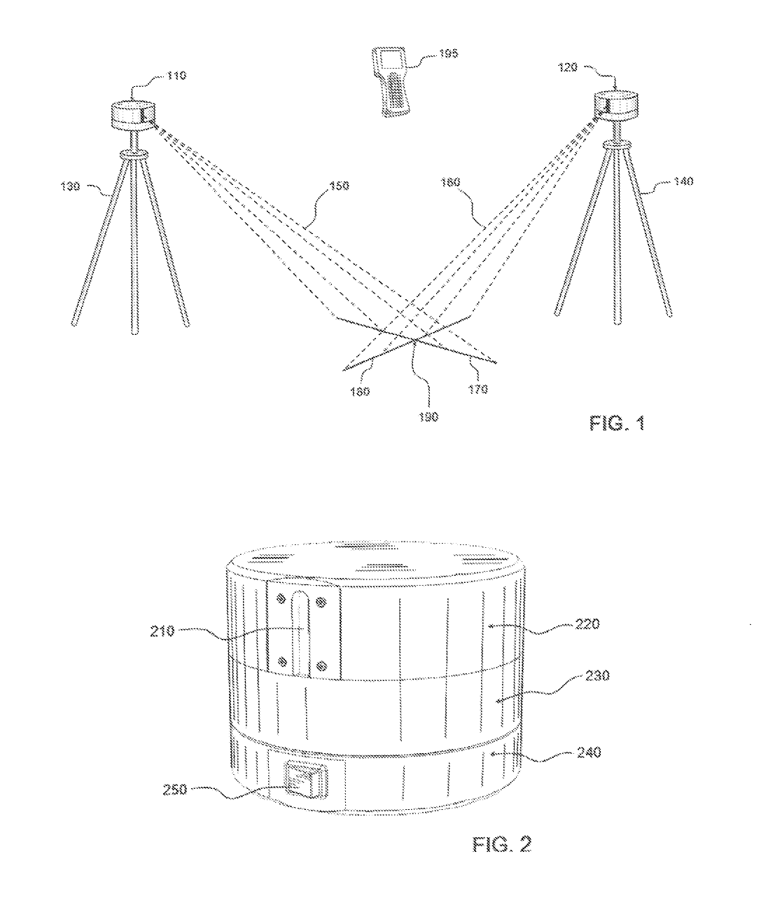

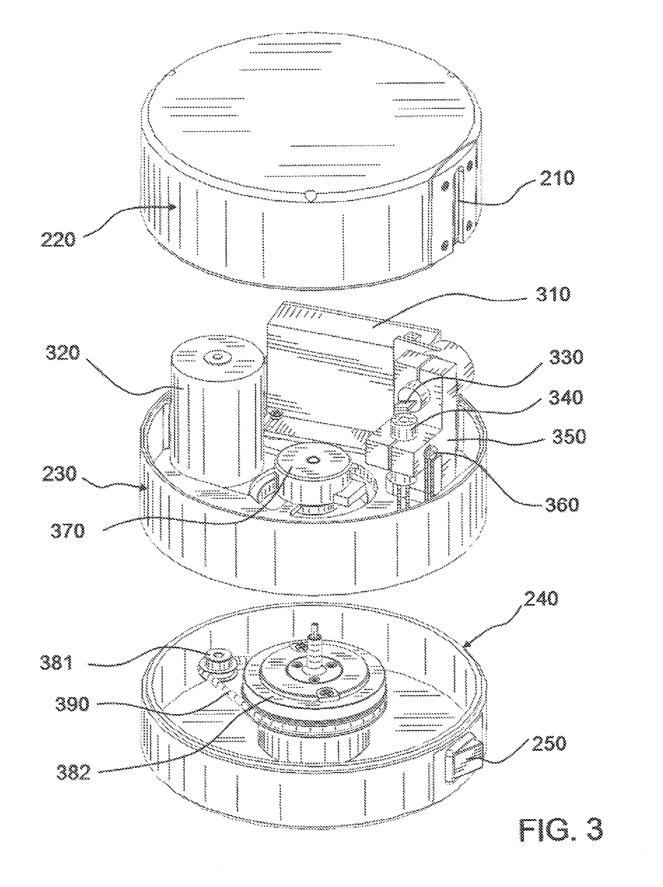

FIG. 1 is a pictorial view of one embodiment of the present invention illustrating the relative alignment of the individual First and Second Laser Projectors 110 and 120 according to one embodiment of the present invention, which are of significance to identify specified locations for surveying or construction. First and Second Laser Projectors 110 and 120 are placed on First and Second Tripods 130 and 140. First Laser Projector 110 projects First Laser Beam 150. Second Laser Projector 120 projects Second Laser Beam 160. First Laser Beam 150 is used to draw First Laser Line 170 and Second Laser Beam 160 is used to draw Second Laser Line 180. The intersecting location of First and Second Laser Lines 170 and 180 designates the Specified Location 190. Data Collector 195 may be employed as a wireless engineering survey data collection system configured for survey data capture, wireless connectivity via multiple alternative formats/protocols, and high precision survey grade angle and distance measurement calculation. The illustrated embodiment is thus configured for use with a Data Collector capable of in-field coordinate geometry. Data Collector 195 interfaces with the wireless digital communications included in Single Board Computer 310 (FIG. 3) of Laser Projectors 110 and 120.

FIG. 2 shows one embodiment of the present invention. In this embodiment, Laser projectors 110 and 120 similarly comprise a Base Housing 240, a Rotation Assembly 230 and Top Cover 220. The upper portion of Laser Projectors 110 and 120 are able to rotate about the vertical axis. Rotation Assembly 230 and Top Cover 220 are connected and rotate 180 degrees over the stationary Base Housing 240. Top Cover 210 has a Laser Window through which a laser beam is projected.

Referring to FIG. 3 the Rotation Assembly 230 and Top Cover 220 are capable of rotating 180 degrees over Base Housing 240 using a drive system comprised of a Motor 320, Encoder 370, First Pulley 381, Second Pulley 382, and Drive Belt 390. The laser 340 and Galvanometer 330 are supported by Laser Mount 350. A laser beam is produced by and projected from the Laser 340. The laser beam is reflected and accurately actuated by the Galvanometer 330. Light Detector 360 is mounted in an internal location that is visible from the outside through Laser Window 210. Light Detector 360 detects a laser beam when projected from the alternate First and Second Laser Projectors 110 or 120. Light Detector 360 is used for set-up and calibration. A Single Board Computer 310 includes one or more processors and system memory and is used to control the Motor 320, Encoder 370, Light Detector 360 and Galvanometer 330. On/Off Switch 250 controls the main power to First and Second Laser Projectors 110 and 120

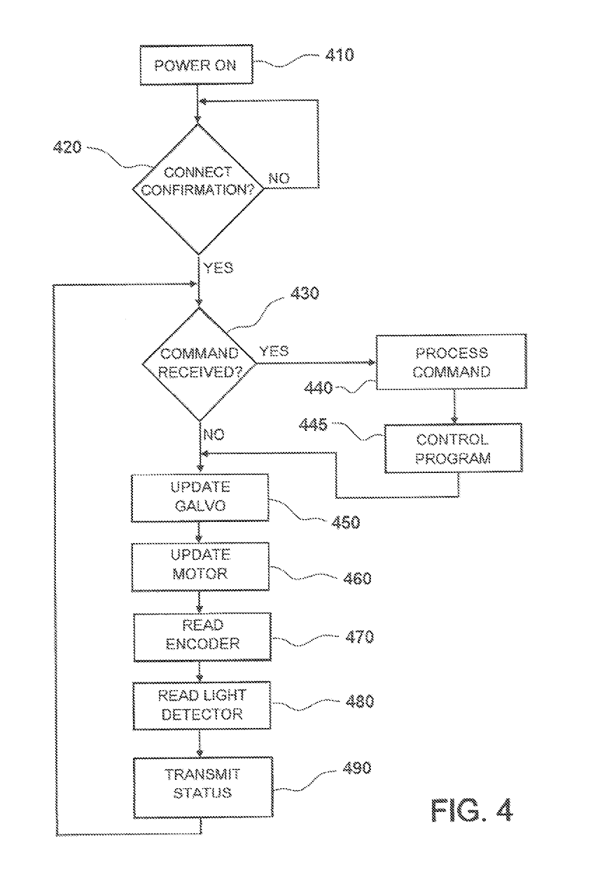

FIG. 4 in accordance with the present invention illustrates the flow of operation, sometimes referred to as a functional block diagram. The first step in the operation is carried out by Power On 410. Power On 410 initiates a Control Program that is stored in the ROM contained in Single Board Computer 310 and associated with First and Second Laser Projectors 110 and 120, which controls the detection and selection of each command and adjustment of operating parameter(s) for the respective instructions.

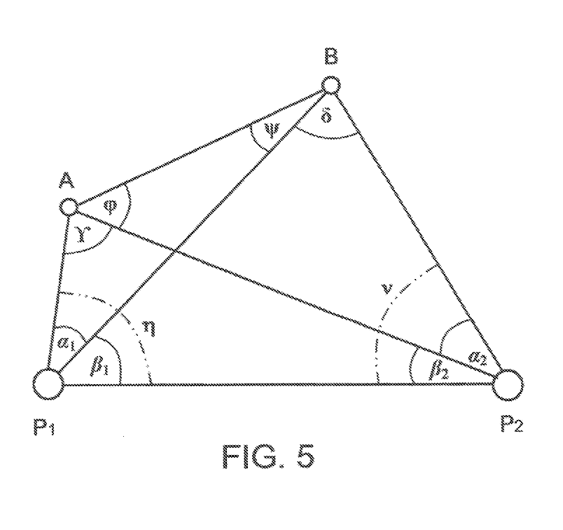

When First and Second Laser Projectors 110 and 120 are turned on, the Connect Confirmation 420 instruction is initiated to ensure a wireless connection is established between Data Collector 195 and the Single Board Computer 310 on both First and Second Laser Projectors 110 and 120. When an instruction is received from Command Received 430, Process Command 440 begins to collect data and provide instruction with Control Program 445. Control Program 445 and the calculations included herein are explained in reference to FIG. 5 and further explained in the entire Detailed Description of the Invention. When the user inputs an operating parameter or instruction into the Data Collector 195, the Command Received 430 initiates the Process Command 440. When Process Command 440 is received, Control Program 445 calculates the parameters and provides instructions to Update Galvo 450, Update Motor 460, Read Encoder 470, and Light Detector 480. Transmit Status 490 then sends information to Data Collector 195 via wireless connection. The entire process is repeated until the parameters and instructions calculated by Control Program 445 are complete and the corresponding data is stored and recorded.

The systems and methods embodying the present invention can be programmed in any suitable language and technology, such as, but not limited to: C, C++; Visual Basic; Java; VBScript; Jscript DHTM1; XML and CGI. Alternate versions may be developed using other programming languages.

The two-way wireless data communication may utilize, but is not limited to, Radio Communication or Wi-Fi (Wireless Fidelity). First Laser Projector 110 and Second Laser Projector 120 each include two way wireless data communication.

### Operation—FIGS. 1, 3, 4, 5

In use, a Laser 340 directs a laser beam toward a Galvanometer 330. A Galvanometer is an analog electromechanical transducer that produces a rotary deflection or some type of pointer in response to electric current flowing through its coil. The Galvanometer 330 reflects and actuates the laser beam and accurately projects the laser beam on to the ground or other surface. The projected position of the laser beam is vertically moved and accurately controlled by the Galvanometer 330. The laser beam is actuated to draw a laser line on the ground or other surface. First Laser Projector 110 produces First Laser Line 170 and Second Laser Projector 120 produces Second Laser Line 180. When the Rotation Assembly 230 and Top Cover 220 are pivoted with respect to Base Housing 240, the laser beam is still accurately projected on the ground or other surface, and the projected position of the laser beam is horizontally moved. By both moving the laser beam vertically with the Galvanometer 330 and horizontally with the Rotation Assembly 230, First Laser Line 170 and Second Laser Line 180 are accurately projected to create Specified Location 190.

In more detail, referring to FIG. 1 in order to accurately calculate and identify the specified placement of First Laser Line 170 and Second Laser Line 180, and furthermore identify Specified Location 190, it is necessary to define the intersecting location for the First Laser Line 170 and the Second Laser Line 180. The intersecting laser lines are used to identify the position of Specified Location 190 by fixing its position relative to two or more mapped or known points, and the starting position of First Laser Projector 110 and Second Laser Projector 120. The Observation of angles made at unknown points is referred to as resection. Resection simply reverses the intersection process by using crossed back bearings, where the starting position is the unknown. Two or more bearings to mapped, known points are taken; their resultant lines of position drawn from the known points to where they intersect will reveal the starting position of First Laser Line 170 and Second Laser Line 180, or the location of Laser Projector 110 and Laser Projector 120.

FIG. 5 illustrates the formula or problem in planar surveying used to calculate the position of First and Second Laser Projectors 110 and 120 and the specified location 190. As Illustrated in FIG. 5 there are two known points A and B, and two unknown points P₁ and P₂. P₁ and P₂ represent First and Second Laser Projectors 110 and 120. Points A and B are locations that have been identified prior to starting the calculations and prior using the specified formula. An example of point A and B is the corner of a defined property or construction lot and an identified point that is a measured distance from the corner of the defined property or construction lot. From P₁ and P₂ an observer measures the angles made by the lines of sight to each of the other three points. The problem is to find the positions of P₁ and P₂. The angles measured are (α₁, β₁, α₂, β₂). Since it involves observations of angles made at unknown points, the problem is an example of resection.

In one embodiment of the present invention the process for measuring the angles is accomplished by first targeting Laser Projector 110 and Laser Projector 120 toward each other. In reference to FIG. 5, Laser Projector 110 is represented by P₁ and Laser Projector 120 is represented by P₂. Targeting First Laser Projector 110 and Second Laser Projector 120 toward each other creates reference angles for both First Laser Projector 110 and Second Laser Projector 120. The Light Detector 360 located in First Laser Projector 110 is able to detect the laser beam targeted from Second Laser Projector 120. The Light Detector 360 located in Second Laser Projector 110 is able to detect the laser beam targeted from First Laser Projector 110. When the Light Detector 360 located in both First Laser Projector 110 and Second Laser Projector 120 have simultaneously detected laser beams from the corresponding Laser Projectors, it is known that the Laser Projectors are oriented correctly and the correct reference angle has been created.

In further reference to FIG. 5, once the reference angle is identified and recorded, the coordinates for known locations A and B can be identified and recorded. This is accomplished by first intersecting First Laser Line 170 and Second Laser Line 180 over known point A and recording the angles η and β2. Once point A is identified and recorded, point B can be identified by intersecting First Laser Line 170 and Second Laser Line 180 over the known point B and recording the angles ν and β1.

In further reference to FIG. 5, once the reference angles and the coordinates for the two known locations are identified and recorded, it is possible to calculate the location of P₁ and P₂. In order to identify positions P₁ and P₂ we must first define the following angles: γ=P₁AP₂, δ=P₁BP₂, φ=P₂AB, ψ=P₁BA. As a first step we will solve for φ and ψ. The sum of these two unknown angles is equal to the sum of β₁ and β₂, yielding the following equation: φ+ψ=β₁+β₂:

A second equation can be found as follows. The law of sines yields

$$\frac{AB}{{P}_{2} B} = \frac{sin {α}_{2}}{sin φ}$$

$$and$$

$$\frac{{P}_{2} B}{{P}_{1} {P}_{2}} = \frac{sin {β}_{1}}{sin δ}$$

combining these together we get

$$\frac{AB}{{P}_{1} {P}_{2}} = \frac{sin {α}_{2} sin {β}_{1}}{sin φ sin δ}$$

An entirely analogous reasoning on the other side yields

$$\frac{AB}{{P}_{1} {P}_{2}} = \frac{sin {α}_{1} sin {β}_{2}}{sin ψ sin γ}$$

Setting these two equal gives

$$\frac{sin φ}{sin ψ} = \frac{sin γ sin {α}_{2} sin {β}_{1}}{sin δ sin {α}_{1} sin {β}_{2}} = k$$

Using a known trigonometric identity this ratio of sines can be expressed as the tangent of an angle difference:

$$tan \frac{φ - ψ}{2} = \frac{k - 1}{k + 1} tan \frac{φ + ψ}{2}$$

This is the second equation we need. Once we solve the two equations for the two unknowns φ and ψ, we can use either of the two expressions above for

$$\frac{AB}{{P}_{1} {P}_{2}}$$

to find P₁P₂ since AB is known. We can then find all specified locations using the law of sines.
When the four angles (α₁, β₁, α₂, β₂) and the distance AB are provided the calculation proceeds as follows:

$$Calculate γ = π - {α}_{1} - {β}_{1} - {β}_{2} , δ = π - {α}_{2} - {β}_{1} - {β}_{2}$$

$$Calculate k = \frac{sin γ sin {α}_{2} sin {β}_{1}}{sin δ sin {α}_{1} sin {β}_{2}}$$

$$Let s = {β}_{1} + {β}_{2} , d = 2 arc tan [ \frac{k - 1}{k + 1} tan ( s / 2 ) ] and then$$

$$ϕ = ( s + d ) / 2 , ψ = ( s - d ) / 2.$$

$$Calculate$$

$${P}_{1} {P}_{2} = AB \frac{sin φ sin δ}{sin {α}_{2} sin {β}_{1}} , \\ or equivalently , \\ {P}_{1} {P}_{2} = AB \frac{sin ψ sin γ}{sin {α}_{1} sin {β}_{2}} ,$$

If one of these fractions has a denominator close to zero, use the other one.

Once a known angle, two or more known coordinates and the positions of First Laser Projector 110 and Second Laser Projector 120 have been calculated, identified and recorded, it is then possible to accurately calculate, identify and record any number of additional specified locations. In order to calculate, identify and record additional locations, it is necessary to calculate and record the inverse of the X and Y coordinates for each additional targeted location. The angles X and Y, or analog data are then stored in Data Collector 195 and can be used by Single Board Computer 310 to control the driving and adjustment devices accordingly. The angles represent a reference to the horizontal and vertical angle measuring devices used in First Laser Projectors 110 and Second Laser Projector 120 and relate to the traditional optical or sighting of First Laser Line 170 or Second Laser Line 180.

### ADVANTAGES OF THE INVENTION

From the description above, the advantages of the present invention include, without limitation:
a) The apparatus and method can accurately calculate and identify specified locations without the use of a stadia rod or prism.
b) The apparatus and method requires only one person to operate.
c) The apparatus and method utilize visible laser beams that are actuated to draw a line for better operator visibility.
d) The apparatus and method utilize two or more laser lines that intersect at specified locations for simplified position identification.
e) The apparatus and method reduces potential measurement error by minimizing the required amount of human measurement and calculation.
f) The apparatus and method automatically compensates for uneven terrain and allows the user to accurately measure X and Y distance over variation in elevation.
g) The apparatus and method requires minimal training.

### CONCLUSION, RAMIFICATIONS, AND SCOPE

In broad embodiment, the present invention provides a unique optical instrument for identifying specified locations. The present system is primarily comprised of solid state devices for ease of operation and maintenance, while providing continuously accurate operation. The present system is controlled using a wireless handheld device or data collector. When turned on, the referenced Laser Projectors and Data Collector automatically connect and established an independent wireless network. When used as a surveying system, the present invention may eliminate required operators while yet providing accurate coordinate data. The present system minimizes the need for individual measurement, and therefore reduces the opportunity for human error. The present system uses two or more visible laser lines that intersect at specified locations. Furthermore, the present invention has additional advantages that:
Can be used as a surveying system to identify key locations.
Can be used in Civil Engineering to coordinate and layout roads, trails, and buildings.
Can be used in construction to identify the location of framing, plumbing, electrical, tile, decks and patios, or fences.
Can be used for assembly line placement, shop layout, interior rack or storage layout, or identifying the location and placement of objects or workspace within a defined space.
Can be used with large scale paint templates and assist the placement of large logos, or the generation of graphics on pools, equipment or buildings.
Although the use of two Laser Projectors has been described in the embodiment illustrated in FIG. 1, the Laser Projectors may be used independently or with more than two, if so desired.

It is to be understood, however, that even though numerous characteristics and advantages of the present invention have been set forth in the foregoing description, together with details of the structure and function of the invention, the disclosure is illustrative only, and changes may be made in detail especially in matters of shape, size, and arrangement of parts within the principles of the invention to the full extent indicated by the broad general meaning of the terms which the appended claims are expressed. Thus the scope of the embodiments should be determined by the appended claims and their legal equivalents, rather than by the examples given.

We claim:

1. A laser projection system for identifying specified locations on varied surfaces, comprising:
a first laser projection apparatus configured to controllably project a first laser line onto a surface;
a second laser projection apparatus configured to controllably project a second laser line onto the surface; and
a controller computing device communicatively coupled to the first laser projection apparatus and the second laser projection apparatus, the controller computing device configured to instruct the first laser projection apparatus and the second laser projection apparatus how to project the first laser line and the second laser line so that the first laser line and the second laser line intersect at a specified location.

2. The laser projection system of claim 1, wherein the controller computing device comprises a wireless computing device communicatively coupled to the first laser projection apparatus and the second laser projection apparatus via radio communication.

3. The laser projection system of claim 2, wherein the controller computing device is configured to enable a user to manually adjust how to project the first laser line and the second laser line so that the first laser line and the second laser line intersect at the specified location.

4. The laser projection system of claim 3, wherein the controller computing device is configured to store manually adjusted coordinates of the specified location.

5. The laser projection system of claim 1, wherein the controller is configured to instruct the first laser projection apparatus and the second laser projection apparatus how to project the first laser line and the second laser line in a manner that adjusts for one or more of:
variances or irregularities in the surface; and
positional differences between one or more of the first laser projection apparatus the second laser projection apparatus, or the surface.

6. The laser projection system of claim 1, further comprising one or more additional laser projection apparatus controlled by the controller computing device to project one or more additional laser lines at specified coordinates.

7. The laser projection system of claim 1, wherein the controller computing device is configured to compute a position of the first laser projection apparatus and the second laser projection apparatus by:
instructing the first laser projection apparatus to project a first laser at the second laser projection apparatus, instructing the second laser projection apparatus to project a second laser at the first laser projection apparatus, and calculating a parallel reference angle between the first laser projection apparatus and the second laser projection apparatus;
instructing the first laser projection apparatus to project the first laser at a first known location, instructing the second laser projection apparatus to project the second laser at the first known location, and calculating both a first angle between the parallel reference angle and the first laser and a second angle between the parallel reference angle and the second laser;
instructing the first laser projection apparatus to project the first laser at a second known location, instructing the second laser projection apparatus to project the second laser at the second known location, and calculating both a third angle between the parallel reference angle and the first laser and a fourth angle between the parallel reference angle and the second laser; and
calculating a location of the first laser projection apparatus and the second laser projection apparatus based on one or more of:
the parallel reference angle;
the first and second known locations; and
the first, second, third, and fourth reference angles.

8. The laser projection system of claim 1, wherein the controller computing device is configured to instruct one or more of the first laser projection apparatus or the second laser projection apparatus to adjust a length of the first laser line or the second laser line.

9. A laser projection apparatus for projecting a laser line onto varied horizontal surfaces, comprising:
a laser projection housing that includes:
a laser emitter that emits a laser beam; and
a rotary deflection device that reflects the laser beam to project a laser line onto a varied horizontal surface, the rotary deflection device configured to project the laser line onto the varied horizontal surface by controllably actuating a vertical position of the reflected laser beam; and
a rotation carriage that rotates about a vertical axis, the rotation carriage connected to the laser projection housing to controllably actuate a horizontal position of the projected laser line on the varied horizontal surface.

10. The laser projection apparatus of claim 9, wherein the rotary deflection device controllably varies a visible length of the projected laser line.

11. The laser projection apparatus of claim 9, further comprising a light detector configured to detect a different laser beam emitted from a different laser projection apparatus.

12. The laser projection apparatus of claim 9, further comprising a top cover that includes a window through which the laser beam is emitted from the laser projection apparatus.

13. The laser projection apparatus of claim 9, wherein the rotary deflection device comprises a galvanometer.

14. The laser projection apparatus of claim 9, further comprising a communications device configured to communicate with one or more of:
one or more other laser projection apparatus; and
one or more controller devices.

15. The laser projection apparatus of claim 9, further comprising a computer controller that controls one or more of the rotary deflection device and the rotation carnage.

16. A method for identifying specified coordinates on varied surfaces, comprising:
projecting a first laser line onto a horizontal surface using a first laser projector; and
projecting a second laser line onto the horizontal surface using a second laser projector,
wherein the first laser line and the second laser line are controllably actuated to intersect at a specified coordinate.

17. The method of claim 16, wherein the first laser line and the second laser line intersect at the specified coordinate regardless of differences in elevation between the first laser projector, the second laser projector, and the specified coordinate.

18. The method of claim 17, further comprising adjusting one or more of a length and an offset of one or more of the first laser line or the second laser line so that the first laser line and the second laser line intersect at the specified coordinate regardless of differences in elevation.

19. The method of claim 16, further comprising forming a Wireless Fidelity (Wi-Fi) network between at least the first laser projector, the second laser projector, and a controller device.

20. The method of claim 16, further comprising calculating a location of the first laser projection apparatus and of the second laser projection apparatus, including:
calculating a parallel reference angle between the first laser projector and the second laser projector, based on detecting a first laser at the second laser projector that is emitted by the first laser projector, and detecting a second laser at the first laser projector that is emitted by the second laser projector;
calculating a first reference angle at the first laser projector measured between the parallel reference angle and a first known point and calculating a first reference angle at the second laser projector measured between the parallel reference angle and the first known point, based on pointing the first laser and the second laser at the first known point;
calculating a second reference angle at the first laser projector measured between the parallel reference angle and a second known point and calculating a second reference angle at the second laser projector measured between the parallel reference angle and the second known point, based on pointing the first laser and the second laser at the second known point;
calculating a location of the first laser projector and the second laser projector based on one or more of:
the parallel reference angle;
the first and second known locations;
the first and second reference angles at the first laser projector; and
the first and second reference angles at the second laser projector.
